(19) United States
(12) Patent Application Publication
(10) Pub. No.: US 2020/0254944 A1
(43) Pub. Date: Aug. 13, 2020

(54) HARNESS COMPONENT

(71) Applicants: AutoNetworks Technologies, Ltd., Yokkaichi, Mie (JP); Sumitomo Wiring Systems, Ltd., Yokkaichi, Mie (JP); SUMITOMO ELECTRIC INDUSTRIES, LTD., Osaka-shi, Osaka (JP)

(72) Inventors: Tsutomu Hashimoto, Yokkaichi, Mie (JP); Hiroki Hirai, Yokkaichi, Mie (JP); Kosuke Sone, Yokkaichi, Mie (JP); Toshikazu Saba, Yokkaichi, Mie (JP); Yasuto Takeda, Yokkaichi, Mie (JP); Yoshitaka Ikeda, Yokkaichi, Mie (JP); Kazuyoshi Ohara, Yokkaichi, Mie (JP); Takahiro Maruyama, Yokkaichi, Mie (JP)

(21) Appl. No.: 16/758,021

(22) PCT Filed: Oct. 24, 2018
(86) PCT No.: PCT/JP2018/039552

§ 371 Date: Apr. 21, 2020

(30) Foreign Application Priority Data
Oct. 25, 2017 (JP) 2017-206583

(51) Int. Cl. B60R 16/02; H01B 7/282; H02G 15/04; H02G 3/08; H01R 13/52

(52) U.S. Cl. CPC B60R 16/0207; H01B 7/2825; H01R 13/5221; H02G 3/088; H01R 13/5205; H02G 15/046

(57) ABSTRACT

It is aimed to provide a harness component capable of preventing liquid penetration from between conductors of wires to a mating connector on which a connector case is mounted, and improving workability and productivity during manufacturing. A harness component (1) includes a connector case (7), a plurality of connector terminals (2) arranged in the connector case (7), a plurality of wires (3) electrically connected to the connector terminals (2) and sealing members (5) arranged in clearances between mounting portions (24) formed on the respective connector terminals (2) and the connector case (7). An outer peripheral surface of the mounting portion (24) and an inner peripheral surface of the sealing member (5) and an outer peripheral surface of the sealing member (5) and an inner peripheral surface of the connector case (7) are in close contact with each other. The connector terminal (2) is formed with a penetration preventing portion (251) for preventing liquid penetration.

### BACKGROUND

### Field of the Invention

The invention relates to a harness component in which wires are arranged in a connector case via connector terminals.

### Related Art

A harness component is used for wiring to a control device in various electronic devices used in automotive vehicles. The harness component is composed of wires formed by stranded wires, connector terminals connected to the respective wires and a connector case having the connector terminals arranged therein. Some of electronic devices wired using a harness component may be exposed to liquid, such as oil or water. Liquid that contacts an end part of the wire connected to the electronic device is known to penetrate between strands of the wire by a capillary phenomenon, for example, as described in Japanese Unexamined Patent Publication No. 2009-272188.

The liquid penetrated between the conductors from the end part of the wire on the electronic device side penetrates to an opposite end part of the wire and may intrude into the control device via the connector terminal and the connector case. Accordingly, Japanese Unexamined Patent Publication No. 2009-272188 discloses filling a water sealant between the strands (conductors) of the core exposed portion on the end part of the wire on the control device side, and the core exposed. that has been filled with the water sealant is covered by a waterproof sheet. The sealant prevents penetration of the liquid to the connector terminal provided on the end part of the wire and prevents intrusion of the liquid into the control device.

However, Japanese Unexamined Patent Publication No. 2009-272188 requires an insulation coating to be removed at an intermediate position of the wire to form the core exposed portion. This removal is made while leaving the insulation coating on the end part of the wire, and work efficiency is poor. Further, Japanese Unexamined Patent Publication No. 2009-272188 requires an operation of curing the water sealant and covering the core exposed portion filled with the water sealant by the waterproof sheet after the water sealant is filled between the strands of the core exposed portion. Thus, many labor-hours are required to manufacture the harness component and productivity is poor.

The present invention was developed in view of such a problem, and an object of the invention is to provide a harness component capable of preventing liquid penetration between conductors of a wire to a mating connector, on which a connector case is mounted and improving work efficiency and productivity during manufacturing.

### SUMMARY

One aspect of the invention is directed to a harness component with a connector case, connector terminals arranged in the connector case, wires respectively electrically connected to the connector terminals, and a sealing member arranged in a clearance between the connector case and either a mounting portion formed on the connector terminal, a solid conductor portion of the wire or a relay conductor composed of one conductor for relaying the connector terminal and the wire.

In the harness component of the above aspect, the mounting portion is formed on the connector terminal, the solid conductor portion in the wire or the relay conductor for relaying the connector terminal and the wire. The mounting portion is made of a material as one lump and hence is distinct from bundled conductors of a stranded wire or the like.

In this way, even if the wire is a stranded wire or the like including plural conductors, liquid, such as oil or water, cannot penetrate between the conductors and into the mounting portion by a capillary phenomenon. Further, if the wire is a single-core wire or the like including one conductor, liquid penetrating by a capillary phenomenon to a clearance between the conductor and an insulating coating layer coating the conductor can be prevented from penetrating into the mounting portion. Thus, liquid cannot penetrate to the inside of the connector terminal and a mating connector, and the liquid cannot intrude into a control device or the like to which the mating connector is wired or mounted.

Further, the connector terminal and the conductor portion of the wire can be connected electrically by various means, such as crimping, welding and soldering. Further, the number of processes required to arrange the sealing member in the clearance between the mounting portion and the connector case is small. Thus, work efficiency in electrical connection and the arrangement of the sealing member is improved and productivity in manufacturing the harness component also is improved.

Therefore, according to the harness component of the above aspect, it is possible to prevent the penetration of the liquid from between the conductors of the wires to the mating connector on which the connector case is mounted and to improve work efficiency and productivity during manufacturing.

Note that the harness component can be used for electrical wiring in an automotive vehicle and the like. An assembly of the connector terminal, the wire, the sealing member and the like before being arranged in the connector case is referred to as a terminal-equipped wire.

Harness components are divided into the following three aspects.

In a harness component of a first aspect, the sealing member is arranged in the clearance between the mounting portion of the connector terminal and the connector case, a penetration preventing portion for preventing liquid penetration is formed in the mounting portion or a part located on a side opposite to a side connected to the wire across the mounting portion in the connector terminal, and an outer peripheral surface of the mounting portion and an inner peripheral surface of the sealing member are in close contact with each other while an outer peripheral surface of the sealing member and an inner peripheral surface of the connector case are in close contact with each other.

In a harness component of a second aspect, the sealing member is arranged in the clearance between the mounting portion of the conductor and the connector case, the mounting portion is made of a solid material preventing liquid penetration, and an outer peripheral surface of the mounting portion and an inner peripheral surface of the sealing member are in close contact with each other while an outer peripheral surface of the sealing member and an inner peripheral surface of the connector case are in close contact with each other.

In a harness component of a third aspect, the sealing member is arranged in the clearance between the mounting portion of the relay conductor and the connector case, and an outer peripheral surface of the mounting portion and an inner peripheral surface of the sealing member are in close contact with each other while an outer peripheral surface of the sealing member and an inner peripheral surface of the connector case are in close contact with each other.

In the harness components of these various aspects, the mounting portion is formed on the connector terminal, the conductor of the wire or the relay conductor. Thus, no clearance through which liquid can penetrate is formed between the mounting portion and the sealing member when the sealing member is arranged in the clearance between the mounting portion and the connector case. The outer peripheral surface of the mounting portion and the inner peripheral surface of the sealing member are in close contact with each other. Further, no clearance through which liquid can penetrate is formed between the sealing member and the connector case, and the outer peripheral surface of the sealing member and the inner peripheral surface of the connector case are in close contact with each other.

In the harness components of the various aspects, the wire may be composed of bundled conductors like a stranded wire. When liquid, such as oil or water, penetrates between the conductors of the wire from an end part of the wire on an electronic device side in the harness component, this liquid penetrates to the conductor located on an end part of the wire on the connector terminal side by a capillary phenomenon. However, the connector terminal is formed with the penetration preventing portion in the harness component of the first aspect. Thus, the liquid penetrated to the conductor cannot pass through the inside of the connector terminal. Further, the mounting portion is formed in the harness components of the second and third aspects. Thus, the liquid penetrated to the conductor cannot pass through the inside of the connector terminal.

Further, in the harness component of the second aspect, the wire may be composed of one conductor like a single-core wire. In this case, liquid does not penetrate into the conductor of the wire. Further, if the liquid penetrates between the conductor of the wire and an insulating coating layer coating the conductor in this case, this liquid cannot pass through the inside of the connector terminal due to the conductor portion serving as the mounting portion.

Note that, in the harness component of the first aspect, the penetration preventing portion may be formed inside the mounting portion or may be located on a side to be connected to the mating connector rather than the inside of the mounting portion. Further, in the harness component of the first aspect, the wire may be partially located inside the mounting portion.

Further, in the harness components of the various aspects, the liquid prevented from penetrating into the connector terminal by the penetration preventing portion or the mounting portion, or the liquid penetrated to the conductor portion is going to penetrate to the mating connector, on which the connector case is mounted, along the outer peripheral surface of the connector terminal or the outer peripheral surface of the sealing member. At this time, the outer peripheral surface of the mounting portion and the inner peripheral surface of the sealing member are in close contact with each other, and the outer peripheral surface of the sealing member and the inner peripheral surface of the connector case also are in close contact with each other. Thus, the liquid cannot penetrate to the mating connector. In this way, the liquid cannot intrude from the connector terminal and the connector case into a control device or the like that is wired to the mating connector.

### BRIEF DESCRIPTION OF THE DRAWING

FIG. 1 is a section showing a harness component according to a first embodiment.

FIG. 2 is a plan view showing the harness component according to the first embodiment.

FIG. 3 is a perspective view showing a terminal-equipped wire used in the harness component according to the first embodiment.

FIG. 4 is a section showing the terminal-equipped wire inserted in an insertion hole of a connector case according to the first embodiment.

FIG. 5 is a perspective view showing each constituent component of the terminal-equipped wire according to the first embodiment.

FIG. 6 is a perspective view showing a terminal-equipped wire used in a harness component according to a second embodiment.

FIG. 7 is a section showing the terminal-equipped wire inserted in an insertion hole of a connector case according to the second embodiment.

FIG. 8 is a perspective view showing each constituent component of the terminal-equipped wire according to the second embodiment.

FIG. 9 is a perspective view showing a terminal-equipped wire used in a harness component according to a third embodiment.

FIG. 10 is a section showing the terminal-equipped wire inserted in an insertion hole of a connector case according to the third embodiment.

FIG. 11 is a perspective view showing each constituent component of the terminal-equipped wire according to the third embodiment.

FIG. 12 is a section showing a harness component according to a fourth embodiment.

FIG. 13 is a perspective view showing each constituent component of the harness component according to the fourth embodiment.

FIG. 14 is a perspective view showing a terminal-equipped wire used in the harness component according to the fourth embodiment.

FIG. 15 is a perspective view showing a terminal-equipped wire according to a fifth embodiment.

FIG. 16 is a plan view showing another terminal-equipped wire inserted in an insertion hole of a connector case according to the fifth embodiment.

FIG. 17 is a perspective view showing the other terminal-equipped wire according to the fifth embodiment.

FIG. 18 is a plan view showing another terminal-equipped wire inserted in the insertion hole of the connector case according to the fifth embodiment.

FIG. 19 is a perspective view showing the other terminal-equipped wire according to the fifth embodiment.

FIG. 20 is a plan view showing another terminal-equipped wire inserted in the connector case according to the fifth embodiment.

FIG. 21 is a perspective view showing the other terminal-equipped wire according to the fifth embodiment

FIG. 22 is a plan view showing another terminal-equipped wire inserted in the insertion hole of the connector case according to the fifth embodiment.

FIG. 23 is a perspective view showing the other terminal-equipped wire according to the fifth embodiment.

### DETAILED DESCRIPTION

Preferred embodiments according to the aforementioned harness component are described with reference to the drawings.

### First Embodiment

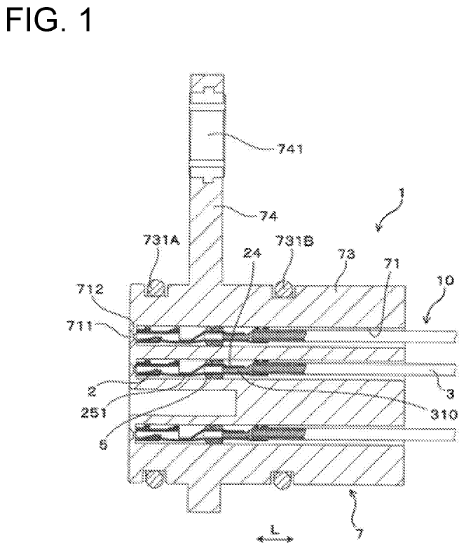

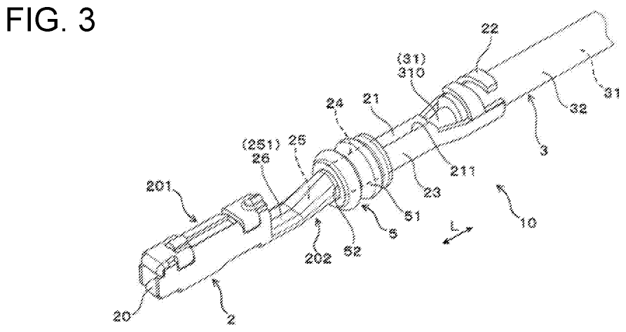

A harness component 1 of this embodiment includes a connector case 7, connector terminals 2, wires 3 and sealing members 5, as shown in FIGS. 1 and 3. The connector case 7 is mounted on a mating connector connected to a control device. The connector terminals 2 are arranged in alignment in the connector case 7. The wires 3 are connected respectively to the connector terminals 2. The sealing member 5 is arranged in a clearance between a mounting portion 24 formed in each connector terminal 2 and the connector case 7.

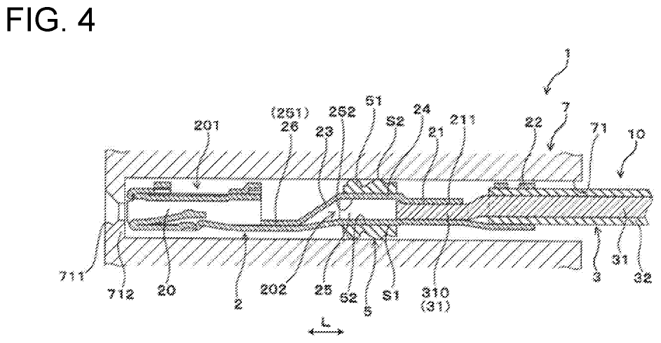

As shown in FIGS. 3 and 4, a penetration preventing portion 251 for preventing liquid penetration is formed in a part of the connector terminal 2 located on a side opposite to a side connected to the wire 3 across the mounting portion 24. The outer peripheral surface of the mounting portion 24 and the inner peripheral surface of the sealing member 5 are in close contact with each other, and the outer peripheral surface of the sealing member 5 and the inner peripheral surface of the connector case 7 are in close contact with each other. Further, the sealing member 5 closes a clearance 51 between the inner peripheral surface of the sealing member 5 and the outer peripheral surface of the mounting portion 24 and also closes a clearance S2 between the outer peripheral surface of the sealing member 5 and the inner peripheral surface of an insertion hole 71.

The harness component 1 of this embodiment is described in detail below.

### (Harness Component 1)

The harness component 1 is used to wire an electronic device such as an actuator or sensor used in an automotive vehicle, such as a four-wheeled automobile or two-wheeled automobile, to a control device for controlling the electronic device. Terminal-equipped wires 10 composed of the connector terminals 2 and the wires 3 are mounted into the connector case 7.

The harness component 1 of this embodiment is used to connect an automatic transmission serving as the electronic device installed in the automotive vehicle to an electronic control unit (ECU) serving as the control device. Oil (working oil) for an automatic shift control operation is used in the automatic transmission. An end part of each wire 3 on the electronic device side in the harness component 1 is connected to a valve body of the automatic transmission. This end part of the wire 3 on the electronic device side is immersed in the oil. The valve body is for controlling an operation in a hydraulic circuit of the automatic transmission and includes solenoid valves serving as actuators and spool valves configured to slide by turning on and off energization to the solenoid valves.

### (Connector Case 7)

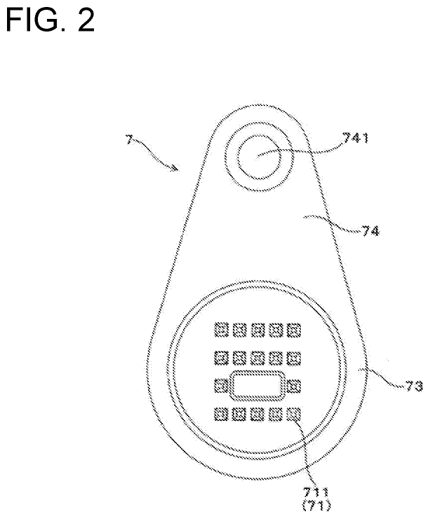

As shown in FIGS. 1 and 2, the connector case 7 is arranged on the automatic transmission or the like and mounted on the mating connector provided in the electronic control unit. The connector case 7 is made of insulating resin. The connector case 7 includes a body 73, a flange 74 for mounting projecting from the body 73, and a mounting hole 741 provided in the flange 74.

Further, a sealing members (O-rings) 731A, 731B are mounted on the body 73 of the connector case 7. The sealing member 731A provides sealing between the connector case 7 and the mating connector when connecting the connector case 7 and the mating connector, and the sealing member 731B provides sealing between the connector case 7 and a case of the automatic transmission when connecting the connector case 7 and the case of the automatic transmission.

Insertion holes 71 are formed laterally side by side in the connector case 7 and receive the respective connector terminals 2. Conductor pins to be connected to the respective connector terminals 2 are provided in the mating connector. A tapered guiding portion 711 is formed on a tip part of the insertion hole 71 for guiding the conductor pin of the mating connector. The connector terminal 2 arranged in the insertion hole 71 is prevented from coming out toward the mating connector by an end wall 712 formed with the tapered guiding portion 711.

Note that each connector terminal 2 arranged in the connector case 7 may be connected to the electronic control unit via the mating connector and the wire 3. Further, the connector case 7 and the mating connector can be used as a relay connector for electrically connecting the valve body and the electronic control unit.

### (Wires 3)

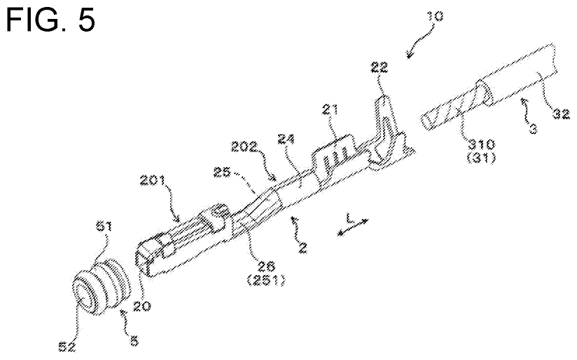

As shown in FIGS. 4 and 5, the wire 3 is formed by a stranded wire in which bundled conductors 31 are stranded. An insulating coating layer 32 made of insulating rubber, resin or the like is provided on the entire outer peripheries of the conductors 31. The insulating coating layer 32 is removed on an end part of the wire 3 to be connected to the connector terminal 2, and a conductor portion 310 in which the outer peripheries of the conductors 31 are exposed is formed on this end part. Note that the exposure of the conductors 31 means that the conductors 31 constitute an outermost peripheral part of the wire 3 when the wire 3 is viewed as a single component. Further, the conductor portion 310 means an assembly of parts of the conductors 31 projecting from an end part of the insulating coating layer 32.

### (Connector Terminals 2)

As shown in FIG. 4, the connector terminal 2 is made of a conductive metal formed as a bent plate. The connector terminal 2 includes an inlet hole 20 into which the conductor pin of the mating connector is inserted, and functions as a female terminal. Note that the connector terminal 2 may be formed as a male terminal such as a conductor pin, and a female terminal into which the male terminal is inserted may be provided in the mating connector.

Further, as shown in FIG. 3, the connector terminal 2 is crimped to the outer peripheries of the conductor portion 310 and the insulating coating layer 32 of the wire 3. Specifically, the connector terminal 2 is formed with a first terminal connecting portion 21 and a second terminal connecting portion 22. The first terminal connecting portion 21 is to be connected to the outer periphery of a tip part of the conductor portion 310. The second terminal connecting portion 22 is adjacent to the first terminal connecting portion 21 and is to be connected to the outer periphery of the insulating coating layer 32 of the wire 3. The first and second terminal connecting portions 21, 22 of this embodiment are formed as crimping portions. The second terminal connecting portion 2 is formed to embrace the insulating coating layer 32 of the wire 3 from opposite circumferential sides.

By directly crimping the connector terminal 2 to the conductor portion 310 and the insulating coating layer 32 of the wire 3, there are four types of components in the harness component 1, i.e. the connector case 7, the wires 3, the connector terminals 2 and the sealing members 5. In this way, the manufacturing and component management of the harness component 1 can be facilitated.

A biting portion 211 is formed in a circumferential part of the inner periphery of the first terminal connecting portion 21 and is configured to bite into the outer periphery of a tip part of the conductor portion 310. The connector terminal 2 of this embodiment is formed as a crimping terminal to be crimped to the conductor portion 310. The connector terminal 2 may be joined to the conductor portion 310 by welding, soldering or the like instead of by crimping.

As shown in FIGS. 4 and 5, the mounting portion 24 of the connector terminal 2 is in a part of the connector terminal 2 in a longitudinal direction L and has a tubular shape. The mounting portion 24 is made unitarily of a material as one lump. The connector terminal 2 is formed by bending a plate, and the mounting portion 24 is a tubular portion 23 formed by rolling the plate into a tube. The connector terminal 2 is formed with an insertion part 201 that is formed with the inlet hole 20 and into which the conductor pin is inserted, and an accommodating part 202 that is formed with an arrangement hole 25. The accommodating part 202 is the tubular portion 23.

The penetration preventing portion 251 of this embodiment is formed as a bottom portion 251 in the arrangement hole 25 in which the conductor portion 310 of the wire 3 is arranged. The penetration preventing portion 251 and the bottom portion 251 are denoted by the same reference sign. The arrangement hole 25 including the bottom portion 251 prevents liquid penetrated to the conductor portion 310 from passing through the inside of the connector terminal 2. The arrangement hole 25 is formed continuously from the inside of the first terminal connecting portion 21 to the inside of the mounting portion 24 inside the tubular portion 23. Further, the arrangement hole 25 of this embodiment is formed up to a position closer to the inlet hole 20 than the inside of the mounting portion 24.

As shown in FIGS. 3 and 4, the bottom portion 251 of the arrangement hole 25 is formed by a closing portion (constricted portion) 26 closed by deforming a part of the tubular portion 23. The closing portion 26 can be formed easily by deforming the plate that is used to make the connector terminal 2. The closing portion 26 separates a space by the inlet hole 20 from a space by the arrangement hole 25 Clearances in a part of the tubular portion 23 where end surfaces of the plate butt against each other and in a part of the tubular portion 23 where the closing portion 26 is formed are filled up by welding, soldering or the like to prevent the liquid pooled in the arrangement hole 25 from leakage.

The closing portion 26 is formed by deforming (squeezing) a part of the tubular portion 23 having a circular cross-section into a part having a flat cross-section. The closing portion 26 is formed by overlapping parts of the material of the plate that form the tubular portion 23, and a clearance between these parts of the material is filled up by a metal material used in welding, soldering or the like.

The end surfaces of the plate butt against each other when the plate is rolled into a tube. A clearance may be formed between the end surfaces butting against each other. In this case, welding, soldering or the like is performed to eliminate the clearance.

As shown in FIG. 5, the mounting portion 24 on which the sealing member 5 is mounted is formed on the outer periphery of a part of the tubular portion 23. The outer peripheral surface of the mounting portion 24 is a cylindrical molding surface having a circular cross-section and is formed using a die so as to be in close contact with the inner periphery of the sealing member 5. Although not shown, the outer peripheral surface of the mounting portion 24 can be made smaller than the outer peripheral surface of the tubular portion 23 in parts located on both sides of the mounting portion 24 in the longitudinal direction L. By making the outer peripheral surface of the mounting portion 24 smaller than the surrounding outer peripheral surfaces, the sealing member 5 mounted on the mounting portion 24 can be positioned with respect to the longitudinal direction L of the connector terminal 2.

As shown in FIG. 4, in this embodiment, a surface 252 of the arrangement hole 25 is located inside the mounting portion 24, and the bottom portion 251 of the arrangement hole 25 is located closer to a side that is to be connected to the mating connector than the inside of the mounting portion 24. The bottomed arrangement hole 25 prevents any liquid that enters the connector terminal 2 from penetrating to a side closer to the mating connector (insertion part 201) than the mounting portion 24.

The bottomed arrangement hole 25 may be formed into any shape provided that any liquid entering the mounting portion 24 is prevented from passing to the inlet hole 20 of the connector terminal 2 (or the mating connector). For example, the bottom portion 251 of the arrangement hole 25 may be formed by arranging a hole filling member made of rubber, resin, metal or the like inside the tubular portion 23 (in the arrangement hole 25). Further, the bottom portion 251 of the arrangement hole 25 may be located inside the mounting portion 24. Further, the conductor portion 310 may be partially in the arrangement hole 25.

The tubular portion 23, the closing portion 26 and the mounting portion 24 also can be formed by a method other than the aforementioned processing method using the plate. For example, the tubular portion 23 and the mounting portion 24 can be formed by drawing.

### (Sealing Members 5)

As shown in FIGS. 1, 4 and 5, the sealing members 5 of this embodiment are mounted individually on the mounting portion 24 of each of the of connector terminals 2 and individually are arranged in each of the insertion holes 71 of the connector case 7. Each sealing member 5 is in close contact with the outer peripheral surface of each of the mounting portions 24 and the inner peripheral surface of each of the insertion holes 71.

Each sealing member 5 is formed as a molded article of a resiliently deformable material such as rubber or resin and includes a sealing portion 51 for closing the insertion hole 71. The sealing portion 51 is provided over the entire circumference of the respective sealing member 5 and contacts the entire circumference of the insertion hole 71 of the connector case 7. A center hole 52 into which the mounting portion 24 is inserted is formed in a central part of each sealing member 5. An outer diameter of the sealing portion 51 of the sealing member 5 is largest in the entire terminal-equipped wire 10 in the longitudinal direction L. A maximum width of the connector terminal 2 in a direction perpendicular to the longitudinal direction (axial direction) L is smaller than the outer diameter of the sealing portion 51.

### (Manufacturing Method)

The harness component 1 can be manufactured (assembled) as follows.

The connector terminal 2 is shaped to include the terminal connecting portions 21, 22, the mounting portion 24, the bottomed arrangement hole 25 and the like by bending the plate and performing shaping, welding and the like.

Further, the insulating coating layer 32 on the end part of the wire 3 on the side of the connector terminal 2 is removed to expose the conductors 31 in this end part as the conductor portion 310. Subsequently, the sealing member 5 is mounted on the outer periphery of the mounting portion 24 of the connector terminal 2. At this time, the sealing member 5 is expanded resiliently in diameter and mounted on the mounting portion 24 of the connector terminal 2.

Subsequently, the tip part of the conductor portion 310 is arranged inside the first terminal connecting portion 21 of the connector terminal 2 and the insulating coating layer 32 on the end part of the wire 3 is arranged inside the second terminal connecting portion 22. The terminal connecting portions 21, 22 are deformed using a tool or the like. Thus, the first terminal connecting portion 21 is crimped to the outer periphery of the tip part of the conductor portion 310 and the second terminal connecting portion 22 is crimped to the outer periphery of the insulating coating layer 32 of the wire 3. In this way, the terminal-equipped wire 11 in which the connector terminal 2 and the sealing member 5 are arranged on the end part of the wire 3 is formed. The terminal-equipped wires 10 are formed in numbers corresponding to the number of the insertion holes 71 in the connector case 7.

Subsequently, the connector terminal 2 and the sealing member 5 of the terminal-equipped wire 10 are inserted respectively into the insertion holes 71 of the connector case 7. At this time, the clearance S2 between the outer peripheral surface of the sealing member 5 and the inner peripheral surface of the insertion hole 71 is closed. Further, the sealing member 5 is compressed by the insertion hole 71 so that the inner peripheral surface of the sealing member 5 and the outer peripheral surface of the mounting portion 24 are held in closer contact with each other. In this way, the harness component 1 in which the terminal-equipped wires 10 are mounted in the connector case 7 is manufactured.

### (Functions and Effects)

Next, functions and effects of the harness component 1 of this embodiment are described.

In the harness component 1 of this embodiment, the penetration of liquid from the wires 3 to the mating connector, on which the connector case 7 is mounted, is prevented by devising the shape of the connector terminals 2 and using the connector terminals 2 and sealing members 5 mounted on the mounting portions 24 of the connector terminals 2.

The end part of the wire 3 on the electronic device side in the harness component 1 is connected to the solenoid valve in the valve body, and this end part is immersed in oil serving as the liquid used in the valve body. Further, if the oil serving as the liquid penetrates between the conductors 31 of the wire 3 from the end part of the wire 3 on the electronic device side in the harness component 1, this oil penetrates to the conductor portion 310 located on the end part of the wire 3 on the side of the connector terminal 2 by a capillary phenomenon. The arrangement hole 25 including the bottom portion 251 is formed inside the mounting portion 24. Thus, the oil penetrated to the conductor portion 310 cannot pass through the inside of the connector terminal 2 toward the inlet hole 20. This oil is pooled in the arrangement hole 25.

The oil pooled in the arrangement hole 25 or the oil penetrated to the conductor portion 310 is going to penetrate along the outer surface of the connector terminal 2 to the mating connector on which the connector case 7 is mounted. However, the clearance S1 between the inner peripheral surface of the sealing member 5 and the outer peripheral surface of the mounting portion 24, and the clearance S2 between the outer peripheral surface of the sealing member 5 and the inner peripheral surface of the insertion hole 71 are closed using the sealing member 5 mounted on the mounting portion 24 of the connector terminal 2, as shown in FIG. 4. Thus, the oil cannot penetrate to the mating connector. In this way, the liquid cannot intrude from the connector terminal 2 and the connector case 7 into the electronic control unit wired to the mating connector.

Further, the connector terminal 2 and the wire 3 can be connected electrically by crimping the respective terminal connecting portions 21, 22 of the connector terminal 2. Further, the sealing member 5 can be mounted easily on the outer periphery of the mounting portion 24 of the connector terminal 2 by being resiliently deformed. The sealing member 5 can be mounted by one process and the number of processes is small. Thus, work efficiency in electrical connection and mounting is improved and productivity in manufacturing the harness component 1 also is improved.

Therefore, according to the harness component 1 of this embodiment, it is possible to prevent the penetration of the liquid from between the conductors 31 of the wire 3 to the mating connector on which the mating connector is mounted and to facilitate work and improve productivity during manufacturing.

Besides automatic transmissions, the harness component 1 can be used in various electronic devices using liquid, such as oil or water. The liquid penetrating between the conductors 31 of each wire 3 in the harness component 1 may be liquids other than oil, such as coolant (cooling liquid).

Further, if liquid, such as oil or water, splashes on the connector case 7 or the harness component 1 from outside, the sealing member 5 can also prevent this liquid from penetrating to the mating connector via the connector terminal 2. In this case, the intrusion of the liquid into the mating connector via the connector terminal 2 is hindered both on the inner periphery and the outer periphery of the sealing member 5.

Further, the liquid such as oil is thought to penetrate not only between the conductors 31, but also between the conductors 31 and the insulating coating layer 32. The penetration of the liquid between the conductors 31 and the insulating coating layer 32 to the mating connector via the connector terminal 2 also is prevented by the configuration of the harness component 1 using the connector terminals 2 and the sealing members 5.

### Second Embodiment

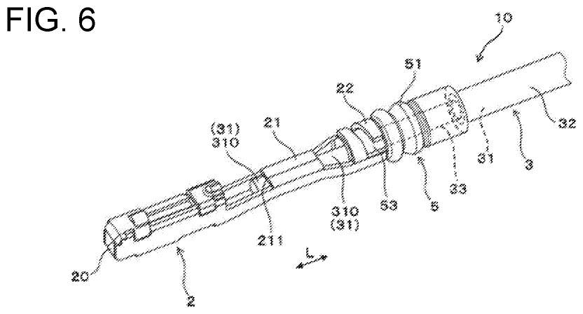

This embodiment has a sealing member 5 arranged in a clearance between a mounting portion 33 of a conductor portion 310 of a wire 3 and a connector case 7, as shown in FIGS. 6 to 8.

The mounting portion 33 of this embodiment is made of a solid material as a part of the conductor portion 310 of the wire 3 to prevent liquid penetration. The wire 3 of this embodiment is a single-core wire composed of one solid conductor 31 and an insulating coating layer 32 coating the conductor 31. The mounting portion 33 is a part of the conductor 31 forming the conductor portion 310, and the conductor portion 310 is a part of the conductor 31 projecting from an end part of the insulating coating layer 32.

The sealing member 5 is mounted on the outer periphery of the mounting portion 33 in the conductor portion 310 and is arranged in an insertion hole 71. The sealing member 5 closes a clearance S1 between the inner peripheral surface of the sealing member 5 and the outer peripheral surface of the conductor portion 310 and also closes a clearance S2 between the outer peripheral surface of the sealing member 5 and the inner peripheral surface of the insertion hole 71. The outer peripheral surface of the mounting portion 33 and the inner peripheral surface of the sealing member 5 are in close contact with each other, and the outer peripheral surface of the sealing member 5 and the inner peripheral surface of the connector case 7 also are in close contact with each other.

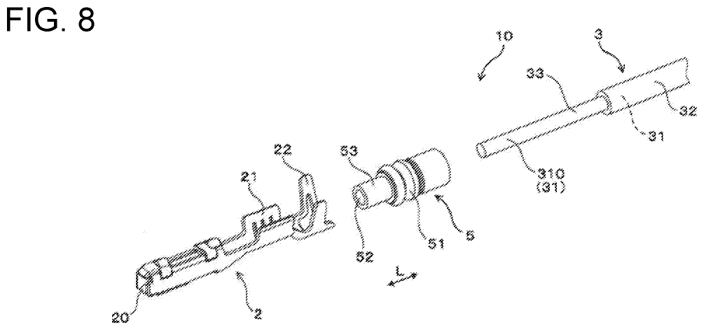

As shown in FIGS. 6 and 8, a connector terminal 2 is formed with a first terminal connecting portion 21 to be connected to the outer periphery of a tip part of the conductor portion 310 and a second terminal connecting portion 22 adjacent to the first terminal connecting portion 21 and to be connected to the outer periphery of the sealing member 5. A biting portion 211 is formed on an end part of the first terminal connecting portion 21 and is configured to bite into the outer periphery of the tip part of the conductor portion 310. Note that the connector terminal 2 may be joined to the conductor portion 310 by welding, soldering or the like.

Further, the sealing member 5 includes a sealing portion 51 for closing the insertion hole 71, a center hole 52 into which the mounting portion 33 is inserted, and a connecting outer peripheral portion 53 with an outer periphery to which the second terminal connecting portion 22 provided in the connector terminal 2 is connected.

Further, the wire 3 can be a stranded wire including bundled conductors 31 instead of being a single-core wire, and a solid mounting portion 33 can be formed by molding in a part of the conductor portion 310 of the wire 3 in a longitudinal direction L. This mounting portion 33 is made of a conductive material that fills up clearances among the conductors 31 in the conductor portion 310 and covers the entire conductor portion 310.

More specifically, the conductor portion 310 can be processed partially or entirely in the longitudinal direction L to mold the mounting portion 33 having an outer peripheral surface (cylindrical surface) for mounting the sealing member 5. The outer peripheral surface of the mounting portion 33 can be molded by sandwiching a part of the conductor portion 310 having the conductive material applied thereto by a die.

Note that the mounting portion 33 can also be formed using an insulating material instead of using the conductive material. In this case, there is no problem even if the part of the conductor portion 310 other than the conductors 31 is made of the insulating material since the conductors 31 in the conductor portion 310 are conductive. Further, in this case, the mounting portion 33 is formed only in a part of the conductor portion 310 on which the sealing member 5 is mounted, and the conductors 31 are exposed in the tip part of the conductor portion 310 to which the connector terminal 2 is connected.

### (Functions and Effects)

In a harness component 1 of this embodiment, oil is unlikely to penetrate into the wire 3 from an end part of the wire 3 on an electronic device side in the harness component 1 since the wire 3 is a single-core wire. However, this oil may enter the clearance between the conductor 31 and the insulating coating layer 32, and might penetrate to an end part of the wire 3 on the side of the connector terminal 2 by a capillary phenomenon.

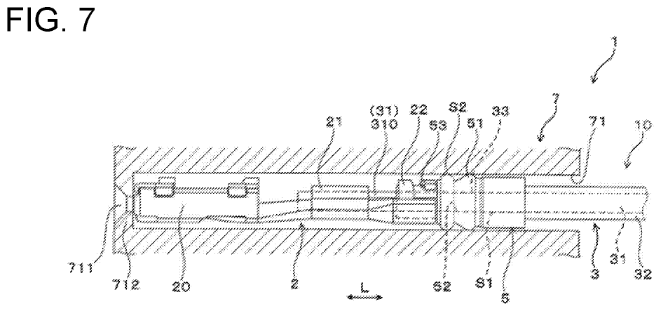

If the oil penetrating into the clearance between the conductor 31 and the insulating coating layer 32 reaches the conductor portion 310, this oil is going to penetrate to the connector terminal 2 along the outer periphery of the conductor portion 310. However, the sealing member 5 closes the clearance S1 between the inner peripheral surface of the sealing member 5 and the outer peripheral surface of the conductor portion 310 and also closes the clearance S2 between the outer peripheral surface of the sealing member 5 and the inner peripheral surface of the insertion hole 71, as shown in FIG. 7. Thus, the oil cannot penetrate to a mating connector via either an inner peripheral side of the sealing member 5 or an outer peripheral side of the sealing member 5. In this way, the intrusion of the liquid into an electronic control unit from the connector terminal 2 and the connector case 7 is prevented.

The other configuration, functions, effects and the like of the harness component 1 of this embodiment are similar to those of the first embodiment. Further, in this embodiment, constituent elements denoted by the same reference signs as in the first embodiment are the same as those in the first embodiment.

### Third Embodiment

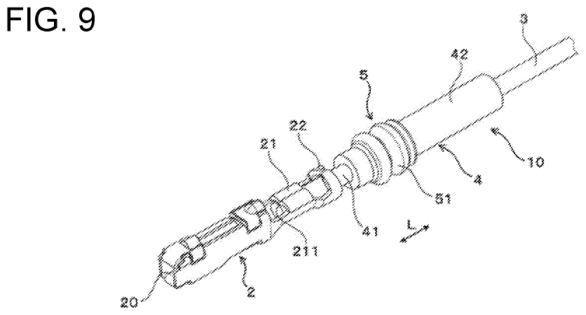

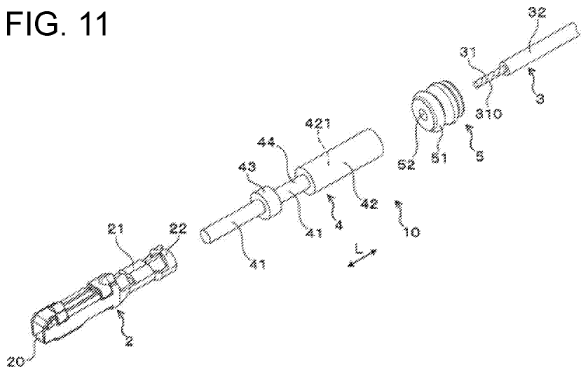

This embodiment provides a sealing member 5 in a clearance between a mounting portion 44 of a relay conductor 4 and a connector case 7, as shown in FIGS. 9 to 11.

The relay conductor 4 is for relaying electrical connection between a connector terminal 2 and a conductor portion 310 of a wire 3. The relay conductor 4 is made of a conductive metal material as one conductor. The relay conductor 4 includes a mounting shaft 41 on which the connector terminal 2 and the sealing member 5 are mounted, and also includes a conductor connecting portion 42 connected to an end part of the wire 3 on the side of the relay conductor 4. The mounting portion 44 is part of the mounting shaft 41 in a longitudinal direction L.

The relay conductor 4 is formed as a solid shaft having a circular cross-sectional shape. A flange 43 is formed on the outer periphery of the mounting shaft 41 and holds the sealing member 5 between the flange 43 and the conductor connecting portion 42 in the longitudinal direction L. The conductor connecting portion 42 is formed into a bottomed cylindrical shape as a closed barrel. The conductor connecting portion 42 is formed with a bottomed arrangement hole 421 along an axial direction of the relay conductor 4 to arrange an end part of the wire 3 inside. Since the relay conductor 4 is formed of one conductor similarly to a single-core wire, liquid does not penetrate therein.

First and second terminal connecting portions 21, 22 of the connector terminal 2 of this embodiment are connected to the outer periphery of the relay conductor 4. A biting portion 211 configured to bite into the outer periphery of the relay conductor 4 is formed on an end part of the first terminal connecting portion 21.

### (Functions and Effects)

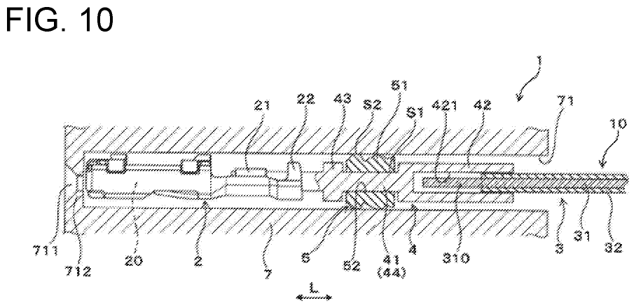

In this embodiment, oil that penetrates between conductors 31 in the wire 3 by a capillary phenomenon reaches the conductor connecting portion 42 of the relay conductor 4. However, the relay conductor 4 is formed by one conductor, and therefore no clearance is formed inside. Accordingly, the oil that reaches the conductor connecting portion 42 does not penetrate into the solid mounting portion 44. Nevertheless, there still is a concern that any oil that reaches the conductor connecting portion 42 may penetrate to the connector terminal 2 along the outer periphery of the relay conductor 4. However, the sealing member 5 closes the clearance 51 between the inner peripheral surface of the sealing member 5 and the outer peripheral surface of the relay conductor 4 and also closes the clearance S2 between the outer peripheral surface of the sealing member 5 and the inner peripheral surface of the insertion hole 71, as shown in FIG. 10. Accordingly, the oil cannot penetrate to either an inner peripheral side of the sealing member 5 or an outer peripheral side of the sealing member 5. Thus, the oil cannot penetrate to a mating connector via the connector terminal 2. In this way, the intrusion of the liquid into an electronic control unit from the connector terminal 2 and the connector case 7 is prevented.

The other configuration, functions, effects and the like of the harness component 1 of this embodiment are similar to those of the first embodiment. Further, in this embodiment, constituent elements denoted by the same reference signs as in the first embodiment are the same as those in the first embodiment.

### Fourth Embodiment

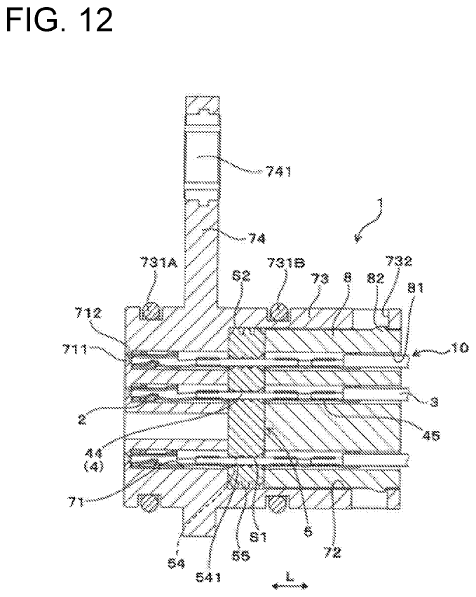

This embodiment has one sealing member 5 arranged for a connector case 7 and commonly used for mounting portions 44 of relay conductors 4 of terminal-equipped wires 10, as shown in FIGS. 12 to 14. This embodiment shows the mounting portions 44 of the relay conductors 4 arranged in the sealing member 5. However, mounting portions to be arranged in the sealing member 5 may be mounting portions 24 provided on connector terminals 2 of the terminal-equipped wires 10 or mounting portions 33 provided on conductor portions 310 of wires 3 of the terminal-equipped wires 10.

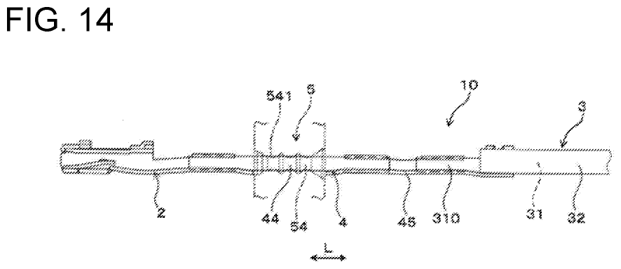

As shown in FIGS. 12 and 14, the connector case 7 of this embodiment has insertion holes 71 that respectively receive the connector terminals 2, and a communication hole 72 communicates with all of the insertion holes 71. The communication hole 72 is a large hole in which the sealing member 5 is arranged. Further, the sealing member 5 of this embodiment includes seal arrangement holes 54 in which the mounting portions 44 respectively are arranged.

The sealing member 5 is arranged in the communication hole 72 formed in the connector case 7. An outer peripheral sealing portion 55 is formed on the outer peripheral surface of the sealing member 5 and is configured to be resiliently deformed by contacting the communication hole 72. An inner peripheral sealing portion 541 is formed in each seal arrangement hole 54 of the sealing member 5 and is configured to be resiliently deformed by contacting the outer peripheral surface of the mounting portion 44. The sealing member 5 is formed to have a circular outer peripheral surface. However, the outer peripheral surface of the sealing member 5 may have a shape other than a circular shape.

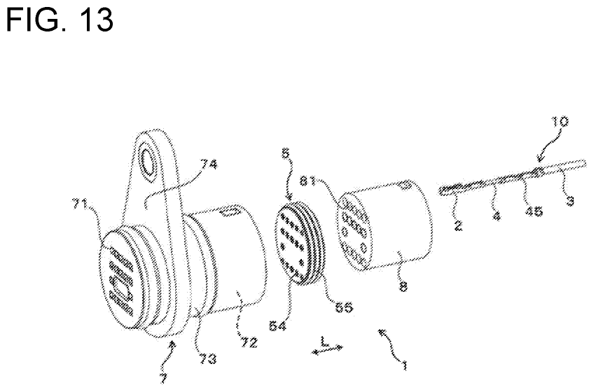

Further, as shown in FIGS. 12 and 13, a plug 8 also is arranged in the communication hole 72 of the connector case 7 and presses the sealing member 5 for preventing the sealing member 5 from coming out of the communication hole 72. The plug 8 is formed with arrangement holes 81 in which the wires 3 and the like are arranged. The arrangement holes 81 are at positions communicating with both the seal arrangement holes 54 in the sealing member 5 and the insertion holes 71 of the connector case 7. Locking projections 82 are formed on the outer periphery of the plug 8 and are to be locked into latching holes 732 formed in a body 73 of the connector case 7.

As shown in FIG. 14, the relay conductor 4 of this embodiment is formed into a shaft shape. The relay conductor 4 is formed by a solid round bar having a substantially constant cross-sectional area along an axial direction thereof. Further, a harness component 1 of this embodiment includes connection terminals 45 for connection (coupling) between the relay conductors 4 and the wires 3. Each relay conductor 4 and the corresponding wire 3 are connected by crimping the connection terminal 45. In this embodiment, the relay conductor 4 can have a simple shape, such as a round bar shape, by using the connection terminal 45.

### (Manufacturing Method)

In manufacturing the harness component 1 of this embodiment, the of terminal-equipped wires 10 are formed by first connecting the connector terminals 2 and the wires 3. Subsequently, the connector terminal 2 of each terminal-equipped wire 10 is inserted into each arrangement hole 81 of the plug 8 and each seal arrangement hole 54 of the sealing member 5. At this time, the seal arrangement hole 54 can be expanded in diameter by resiliently deforming the inner peripheral sealing portion 541 by the connector terminal 2. The mounting portion 44 in each relay conductor 4 is arranged in each seal arrangement hole 54 and the inner peripheral sealing portion 541 contacts each mounting portion 44.

Subsequently, the sealing member 5 and the plug 8 having the terminal-equipped wires 10 arranged therein are arranged in the communication hole 72 of the connector case 7. At this time, the outer peripheral sealing portion 55 is deformed resiliently by the communication hole 72 and the sealing member 5 is pushed into the communication hole 72. When the sealing member 5 and the plug 8 are arranged in the communication hole 72, a compression force acts in a radial direction of the sealing member 5 (direction perpendicular to a longitudinal direction L of the wires 3) and the outer peripheral sealing portion 55 on the outer peripheral surface of the sealing member 5 and the inner peripheral surface of the communication hole 72 are held in close contact with each other. Further, the outer peripheral surface of each mounting portion 44 and the inner peripheral surface of each seal arrangement hole 54 are in close contact with each other.

In this way, clearances S1 between the inner peripheral sealing portions 541 of the respective seal arrangement holes 54 of the sealing member 5 and the outer peripheral surfaces of the respective mounting portions 44 are closed, and a clearance S2 between the outer peripheral sealing portion 55 of the sealing member 5 and the inner peripheral surface of the communication hole 72 also are closed. Then, the harness component 1 having the plurality of terminal-equipped wires 10 mounted in the connector case 7 is manufactured.

Also in this embodiment, an effect of preventing the intrusion of liquid into an electronic control unit from the connector terminals 2 and the connector case 7 by the sealing member 5 and the mounting portions 44 is obtained as in the first to third embodiments. Further, the terminal-equipped wire 10 that is used in the harness component 1 and in which the wire 3 is connected to the connector terminal 2 may be any one of those shown in the first to third embodiments.

The other configuration, functions, effects and the like of the harness component 1 of this embodiment are similar to those of the first to third embodiments. Further, also in this embodiment, constituent elements denoted by the same reference signs as in the first to third embodiments are the same as those in the first to third embodiments.

### Fifth Embodiment

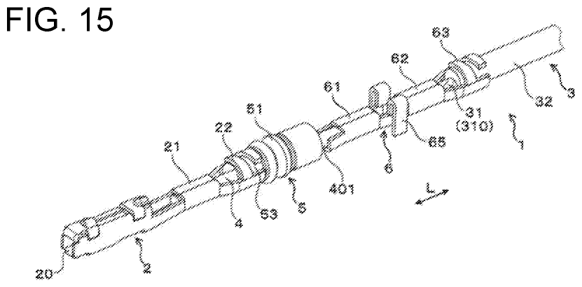

This embodiment has a harness component 1 that includes a connection terminal 6 for connection (coupling) between a relay conductor 4 and a wire 3, as shown in FIGS. 15 to 23.

The connection terminal 6 of this embodiment includes a first connecting portion 61 to be connected to the relay conductor 4 having a shaft shape and a second connecting portion 62 to be connected to a conductor portion 310 on an end part of the wire 3. The relay conductor 4 and the wire 3 are coupled by the connection terminal 6. Further, a third connecting portion 63 to be connected to an insulating coating layer 32 of the wire 3 is formed at a position closer to the wire 3 than the second connecting portion 62. In this embodiment, the relay conductor 4 can be formed by a round bar having a simple shape by using the connection terminal 6.

As shown in FIG. 15, the connection terminal 6 of this embodiment is formed with a projection 65 configured to contact an insertion hole 71 of a connector case 7. The projection 65 can support the connection terminal 6 in the insertion hole 71 by contact the insertion hole 71. The projection 65 projects outward of the connection terminal 6 at a position between the first and second connecting portions 61, 62. Outward means a direction perpendicular to a longitudinal direction L of the connection terminal 6, i.e. outward in a radial direction of the insertion hole 71. Further, the projection 65 is formed by extending parts of a plate forming the connection terminal 6 toward both sides. The longitudinal direction L means an extending direction of the relay conductor 4 and the connection terminal 6.

Note that there may be a tiny clearance between the projection 65 and the insertion hole 71 when a terminal part of a terminal-equipped wire 10 of the harness component 1 is inserted into the insertion hole 71. Also in this case, the projection 65 contacts the insertion hole 71 due to vibration or the like when the harness component 1 is used.

The terminal-equipped wire 10 of the harness component 1 of this embodiment is supported in the insertion hole 71 of the connector case 7 by a sealing portion 51 of a sealing member 5 and the projection portion 65 of the connection terminal 6. This can make the terminal-equipped wire 10 difficult to vibrate with respect to the connector case 7. Thus, the relay conductor 4 can be made less likely to be damaged particularly in a part 401 near an end of the sealing member 5 on the side of the connection terminal 6.

Further, the projection 65 can be formed into various shapes to contact the inside of the insertion hole 71. In the case of using the connection terminal 6, the terminal part of the terminal-equipped wire 10 becomes longer than in the case of not using the connection terminal 6. Thus, it is effective to provide the projection 65 to make the terminal part of the terminal-equipped wire 10 less likely to vibrate due to vibration transmitted to the terminal-equipped wire 10.

The projection portion 65 can be provided at a position maximally distant from the sealing member 5 in the longitudinal direction L, e.g. in an intermediate part of the connection terminal 6 in the longitudinal direction L or in a base part of the connection terminal 6 in the longitudinal direction L. The base part means a part near the wire 3 in the longitudinal direction L of the connection terminal 6.

Further, the projection 65 can be formed into a resiliently deformable shape. In this case, a spring force caused by resilient deformation can be generated to the insertion hole 71 from the projection 65 when the projection 65 comes into contact with the insertion hole 71. The projection portion 65 can be deformed resiliently in inserting the terminal part of the terminal-equipped wire 10 into the insertion hole 71. The projection 65 can more reliably contact the insertion hole 71 by causing the projection 65 to generate the spring force while maintaining easy insertion of the terminal part of the terminal-equipped wire 10 into the insertion hole 71.

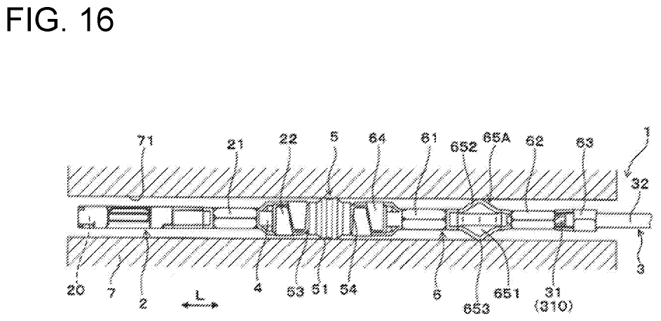

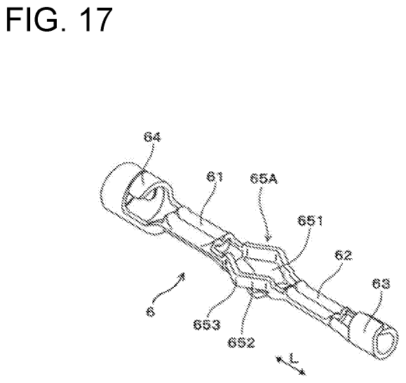

As shown in FIGS. 16 and 17, a projection 65A can be composed of strips 652 on both sides of slits (cutouts) 651 extending along the longitudinal direction L in an intermediate part of the connection terminal 6 in the longitudinal direction L. Each strip 652 is in the form of a beam having both ends in the longitudinal direction L supported on a body of the connection terminal 6. In this case, an intermediate part of each strip 652 in the longitudinal direction L bulges out in a direction perpendicular to the longitudinal direction L to form a projecting apex 653 in this intermediate part, so that the strip 652 can be deformed resiliently. The projecting apex 653 can be formed by bending the strip 652. Further, the projecting apex 653 of each strip 652 projects most outward in the direction perpendicular to the longitudinal direction L and contacts the insertion hole 71.

The strips 652 shown in FIGS. 16 and 17 are formed at three positions, i.e. on both sides in a width direction perpendicular to the longitudinal direction L and on one side in a height direction perpendicular to the width direction. The apices 653 enable all three strips 652 to be deformed resiliently. Besides this, the resiliently deformable strips 652 can be formed only on both sides in the width direction perpendicular to the longitudinal direction L or can be formed only on one side in the height direction.

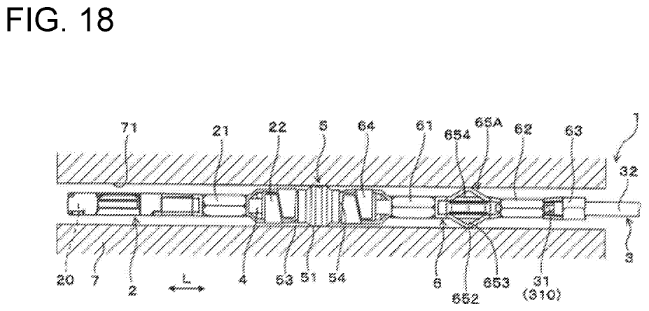

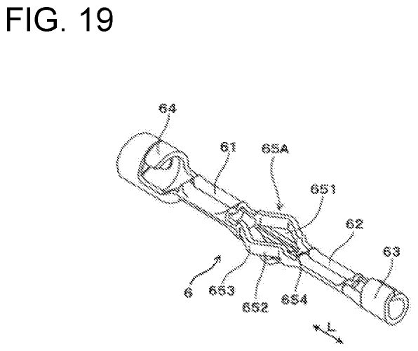

Further, as shown in FIGS. 18 and 19, a reinforcing strip 654 not constituting the projection 65A can be formed between the strips 652. The reinforcing strip 654 can be parallel to the longitudinal direction L. The reinforcing strip 654 can be formed between the strips 652 in a direction about a center axis along the longitudinal direction L of the connection terminal 6. Further, any one of the strips 652 may be used as the reinforcing strip 654 by not forming the projection 65A.

By forming the slits 651 in the connection terminal 6, an electrical resistance value of the connection terminal 6 may be increased and the strength of the connection terminal 6 may be reduced. Accordingly, the electrical resistance value of the connection terminal 6 can be kept low and the strength of the connection terminal 6 can be maintained as high as possible by forming both the reinforcing strip 654 and the strips 652 in the connection terminal 6.

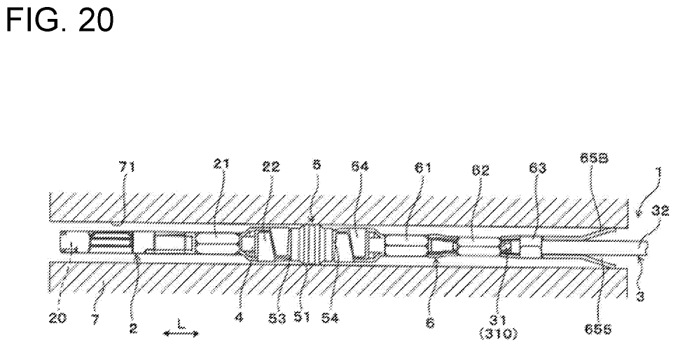

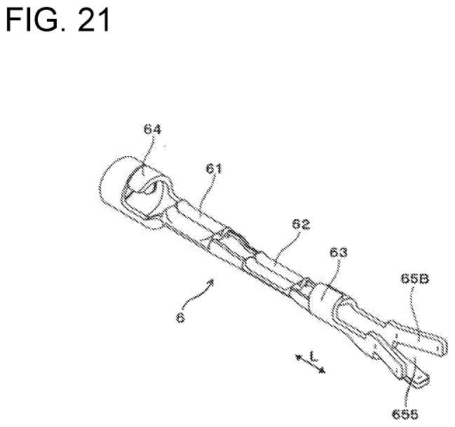

Further, as shown in FIGS. 20 and 21, projections 65B also can be formed by being cut by one or more cutouts 655 formed in a base end part of the connection terminal 6 in the longitudinal direction L. The projections 65B can be formed by being bent in directions perpendicular to the longitudinal direction L. The projections 65B can be deformed resiliently by having a cantilever shape with one end supported on the body of the connection terminal 6.

In this case, tips of the projections 65B can be deformed resiliently when coming into contact with the insertion hole 71 while inserting the terminal part of the terminal-equipped wire 10 into the insertion hole 71. Spring forces can be caused to act on the insertion hole 71 from the projection portions 65B. One, two or more projections 65B can be formed. A case in which three projections 65B are formed is shown in FIGS. 20 and 21.

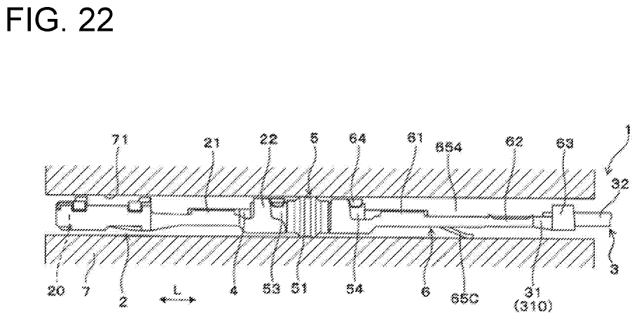

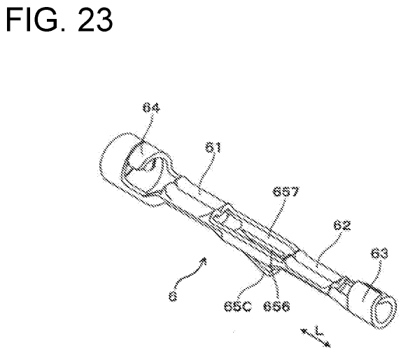

Further, as shown in FIGS. 22 and 23, a projection 65C can be formed as a cantilever having one end in the longitudinal direction L supported on the body of the connection terminal 6 by cutting a part of the connection terminal 6 by a slit (cutout) 656 in an intermediate part of the connection terminal 6 in the longitudinal direction L and raising the cut part. In this case, conductive portions 657 constituting the body of the connection terminal 6 are formed on both sides of the projection 65C in a direction perpendicular to the longitudinal direction L.

Also in this case, the projection 65C is resiliently deformable and can contact the insertion hole 71 by causing a spring force to act. Further, the projection 65C projects obliquely from the body of the connection terminal 6 from a tip side (side of the connection terminal 2) toward a base end side (side of the wire 3) along the longitudinal direction L to facilitate the insertion of the terminal part of the terminal-equipped wire 10 into the insertion hole 71.

Note that the projections 65, 65A, 65B and 65C are not only those that are resiliently deformable, but also those that are hardly resiliently deformed. In this case, a tiny clearance is formed between the projections 65 and the insertion hole 71 when the terminal part of the terminal-equipped wire 10 is inserted into the insertion hole 71. In other words, the projection can be not only the one that has a spring characteristic to be resiliently deformable, but also the one having no spring characteristic.

Also in this embodiment, the sealing member 5 may be used commonly for the mounting portions 44 of the relay conductors 4 of the terminal-equipped wires 10 similarly to the sealing member 5 shown in the fourth embodiment. The other configuration, functions, effects and the like of the harness component 1 of this embodiment are similar to those of the first to fourth embodiments. Further, also in this embodiment, constituent elements denoted by the same reference signs as in the first to fourth embodiments are the same as those in the first to fourth embodiments.

The invention is not limited only to the embodiments and further different embodiments can be employed without departing from the gist of the present invention. Further, the invention encompasses various modifications, modifications within the scope of equivalents and the like.

1. A harness component, comprising:
a connector case;
connector terminals arranged in the connector case;
wires respectively electrically connected to the connector terminals; and
a sealing member arranged in a clearance between a mounting portion formed on the connector terminal, a solid conductor portion of the wire or a relay conductor composed of one conductor for relaying the connector terminal and the wire and the connector case.

2. The harness component of claim 1, wherein:
the sealing member is arranged in the clearance between the mounting portion of the connector terminal and the connector case;
a penetration preventing portion for preventing liquid penetration is formed in the mounting portion or a part located on a side opposite to a side connected to the wire across the mounting portion in the connector terminal, and
an outer peripheral surface of the mounting portion and an inner peripheral surface of the sealing member are in close contact with each other, and an outer peripheral surface of the sealing member and an inner peripheral surface of the connector case are in close contact with each other.

3. The harness component of claim 1, wherein:
the sealing member is arranged in the clearance between the mounting portion of the conductor portion and the connector case;
the mounting portion is made of a solid material preventing liquid penetration, and
an outer peripheral surface of the mounting portion and an inner peripheral surface of the sealing member are in close contact with each other, and an outer peripheral surface of the sealing member and an inner peripheral surface of the connector case are in close contact with each other.

4. The harness component of claim 1, wherein:
the sealing member is arranged in the clearance between the mounting portion of the relay conductor and the connector case; and
an outer peripheral surface of the mounting portion and an inner peripheral surface of the sealing member are in close contact with each other, and an outer peripheral surface of the sealing member and an inner peripheral surface of the connector case are in close contact with each other.

5. The harness component of claim 1, wherein:
the connector case is provided with insertion holes, the connector terminals being inserted respectively into the insertion holes, and
the sealing members mounted respectively on the mounting portions, and are arranged respectively in the insertion holes and are held in close contact with an outer peripheral surface of the respective mounting portions and an inner peripheral surface of the respective insertion holes.

6. The harness component of claim 1, wherein:
the connector case is provided with insertion holes, the connector terminals being inserted respectively into the isertion holes, and a communication hole communicating with the insertion holes,
sealing member includes seal arrangement holes, the mounting portions being arranged respectively in the seal arrangement holes, and
an outer peripheral surface of each of the mounting portions and an inner peripheral surface of each of the of seal arrangement holes are in close contact with each other, and an outer peripheral surface of the sealing member and an inner peripheral surface of the communication hole are in close contact with each other.

7. The harness component of claim 2, wherein:
the wire includes bundled conductors and an insulating coating layer coating the conductors,
the mounting portion is formed to have a tubular shape in a part of the connector terminal in a longitudinal direction, and
the penetration preventing portion is a bottom portion in an arrangement hole, the conductor portion of the wire being arranged in the arrangement hole, the arrangement hole including an inside of the mounting portion.

8. The harness component of claim 7, wherein:
the connector terminal is formed by a bent plate,
the mounting portion is formed as a tubular portion rolled into a tube in the plate, and
the arrangement hole is formed inside the tubular portion and the bottom portion is formed by a closing portion obtained by deforming a part of the tubular portion.

9. The component of claim 3, wherein:
the wire is a single-core wire including one conductor and an insulating coating layer coating the conductor, and
the mounting portion is formed by a part of the conductor projecting from an end part of the insulating coating layer in the single-core wire.

10. The component of claim 4, wherein:
the relay conductor is formed into a shaft shape,
the relay conductor and the wire are coupled by a connection terminal including a first connecting portion connected to the relay conductor and a second connecting portion connected to the wire, and
the connection terminal is formed with a projection configured to contact with an insertion hole of the connector case.
